(19) United States
(12) Patent Application Publication
(10) Pub. No.: US 2016/0277570 A1
(43) Pub. Date: Sep. 22, 2016

(54) FACILITATING CONTROLLED ELECTRONIC COMMUNICATION

(71) Applicant: Dots Communication, Inc., San Jose, CA (US)

(72) Inventors: Dhiraj Marya, San Jose, CA (US); Chiakai Hsu, San Jose, CA (US); Raymond Neil Walsh, II, San Jose, CA (US)

(21) Appl. No.: 14/660,874

(22) Filed: Mar. 17, 2015

(51) Int. Cl. H04M 3/42; H04M 3/48

(52) U.S. Cl. CPC H04M 3/42374; H04M 3/48

(57) ABSTRACT

Disclosed is a system, method, and/or computer program product for facilitating controlled electronic communication. In various embodiments, controlled electronic communication may occur between clients of two or more users. Controlled electronic communication may be initiated between clients of a primary user and a secondary user when each user is available to begin communication. A controlled communication server handles initiation and communication requests, and stores and determines user availability statuses. In one embodiment, a user may indicate an availability time range for which the user is available to initiate communication. Responsive to a determination that each user associated with a communication session is available, instructions are sent to a client of a user to commence controlled electronic communication.

### BACKGROUND

1. Field of Art

The disclosure generally relates to the field of voice communication using an electronic device, and more particularly to systems, methods, and user interfaces for controlling voice communication.

2. Description of Art

Voice communication using an electronic device, for example, a mobile device is well known. A problem with voice communication using a mobile device is that initiating voice communication can be difficult and time consuming. For example, if one party to the communication is not available at the exact time the other party tries to initiate the communication they may engage in “phone tag” in which each party leaves a voicemail message for the other indicating availability. Other methods for dealing with this problem include leaving text or email messages instructing the party to call back at a particular time or arrange for a call at a particular time. However, as quantities of those messages increase, they can be ignored, inadvertently suppressed or forgotten so that the opportunity to establish a subsequent call is lost. Similarly, information displayed regarding “missed calls” on mobile devices is ineffective and incomplete because it is unclear whether the caller is currently available for a call back.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates an example embodiment of an environment for facilitating controlled electronic communication.

FIG. 2 is a block diagram illustrating components of an example machine able to read instructions from a machine-readable medium and execute them in a processor (or controller).

FIG. 3 is a block diagram illustrating components of an example controlled communication server according to one embodiment.

FIG. 4 is a block diagram illustrating the components of an example client according to one embodiment.

FIG. 5 illustrates an example process for facilitating controlled electronic communication.

FIG. 6 shows an example user interface for facilitating controlled electronic communication according to one embodiment.

FIG. 7 shows an example user interface for viewing and managing contacts according to one embodiment.

FIG. 8 shows an example user interface for initiating controlled electronic communication according to one embodiment.

FIG. 9 shows an example user interface for viewing and managing requests for controlled electronic communication according to one embodiment.

FIG. 10 shows an example user interface for viewing and responding to a communication request according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed by way of example embodiments is controlled electronic communication. The controlled electronic communication can be as a system, method and/or a computer program product (e.g., a computer readable storage medium that stores instructions executable by one or more processing units). The environment for facilitating controlled electronic communication includes a controlled communication server, a network, and clients with associated users. The controlled communication server receives, via the network, an initiation request from a client of a primary user. The initiation request is a request by the primary user to begin a communication session with one or more secondary users. In response to receiving the initiation request, the controlled communication server creates an availability status of the primary user that reflects an availability of the primary user to initiate the communication session. The availability status of a user is unique to a particular communication session, so a user may have several availability statuses corresponding to many communication sessions. In one embodiment, a user's availability status changes from available for communication to unavailable for communication when the controlled communication server is aware that a user is unavailable (e.g., by user request, by expiration of a time range, by participation in another communication session, etc.). The controlled communication server also transmits, via the network, a communication request to a client of a secondary user. The secondary user may indicate the secondary user's availability to initiate the communication session by accepting the communication request via the user interface of the client of the secondary user. If the communication request is accepted, which may take place after a period of delay, the controlled communication server receives an availability notification from the client of the secondary user. In response to receiving the availability notification, the controlled communication server determines the availability status of the primary user. If the primary user is available, the controlled communication server sends a confirmation notification to the client of the secondary user. The confirmation notification includes instructions to commence the communication session.

### Example Environment

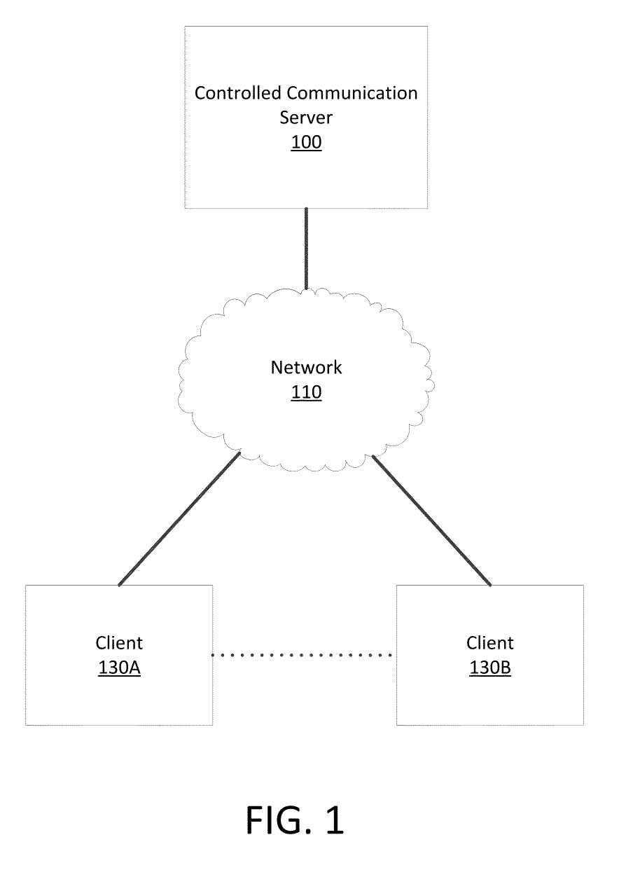

FIG. 1 illustrates an example embodiment of an environment for facilitating controlled electronic communication. The environment includes controlled communication server 100, network 110, and one or more clients 130. In this example, client 130 is embodied as an application operating on an electronic device configured for communication. Note that although only two clients 130A, 130B (generally 130) are shown in FIG. 1, this is only for purpose of illustration; in practice, any number of devices or users may be present in the environment.

Controlled communication server 100 facilitates, via network 100, controlled communication between clients 130 and correspondingly the users of them. Network 110 is any suitable network and may include data and/or telecommunication networks (including mobile communication networks). In some configurations, clients 130 communicate via a wired or wireless communication network to a network service provider, and communicate with controlled communication server 100 through the Internet. In certain configurations, clients 130 can communicate directly with one another without network 110 as indicated in FIG. 1 by a dotted line. For example, clients 130 may communicate via a wired or wireless connection, such as wirelessly via a Bluetooth connection or a wired connection via a Universal Serial Bus (USB). In another embodiment, clients 130 communicate via a cellular (or mobile) network.

In one embodiment, client 130 has a software application that is used to facilitate communication with the controlled communication server 100. In some configurations, clients 130 communicate with the controlled communication server 100 using short message service (SMS) or a browser application on the client 130.

### Example Machine Architecture

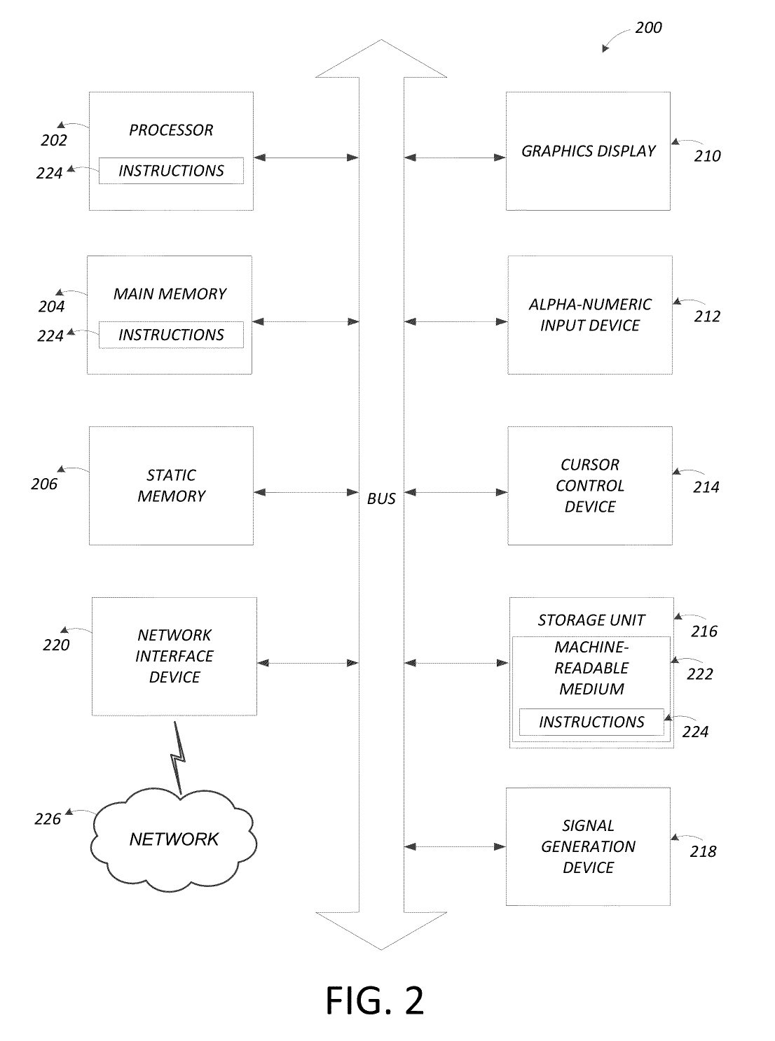

FIG. 2 is a block diagram illustrating components of an example machine able to read instructions from a machine-readable medium and execute them in a processor (or controller). Specifically, FIG. 2 shows a diagrammatic representation of a machine in the example form of a computer system 200. The computer system 200 can be used to execute instructions 224 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes one or more processing units (generally processor 202). The processor 202 is, for example, a central processing unit (CPU), a graphics processing unit (GPU), a digital signal processor (DSP), a controller, a state machine, one or more application-specific integrated circuits (ASICs), one or more radio-frequency integrated circuits (RFICs), or any combination of these. The computer system 200 also includes a main memory 204. The computer system may include a storage unit 216. The processor 202, memory 204 and the storage unit 216 communicate via a bus 208.

In addition, the computer system 206 can include a static memory 206, a display driver 210 (e.g., to drive a plasma display panel (PDP), a liquid crystal display (LCD), or a projector). The computer system 200 may also include alphanumeric input device 212 (e.g., a keyboard), a cursor control device 214 (e.g., a mouse, a trackball, a joystick, a motion sensor, or other pointing instrument), a signal generation device 218 (e.g., a speaker), and a network interface device 220, which also are configured to communicate via the bus 208.

The storage unit 216 includes a machine-readable medium 222 on which is stored instructions 224 (e.g., software or program code) embodying any one or more of the methodologies or functions described herein. The instructions 224 may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 may be transmitted or received over a network 226 via the network interface device 220.

While machine-readable medium 222 is shown in an example embodiment to be a single medium, the term “machine-readable medium” should be taken to include a single medium or multiple media (e.g., a centralized or distributed database, or associated caches and servers) able to store the instructions 224. The term “machine-readable medium” shall also be taken to include any medium that is capable of storing instructions 224 for execution by the machine and that cause the machine to perform any one or more of the methodologies disclosed herein. The term “machine-readable medium” includes, but not be limited to, data repositories in the form of solid-state memories, optical media, and magnetic media.

### Example Controlled Communication Server

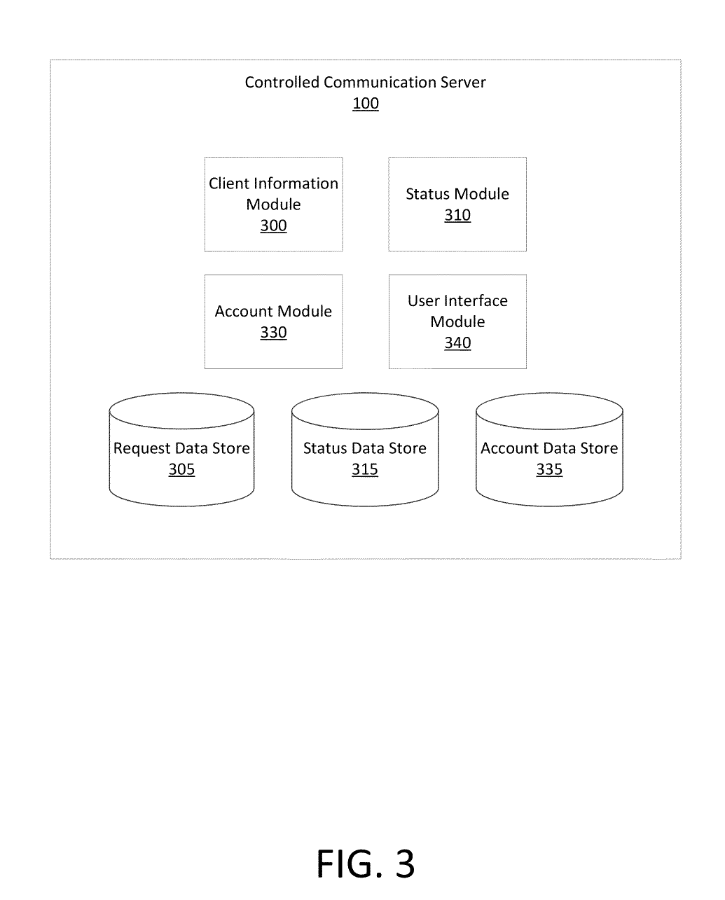

FIG. 3 is a block diagram illustrating components of an example controlled communication server 100. In this example, controlled communication server 100 includes client information module 300, status module 310, account module 330, user interface module 340, request data store 305, status data store 315, and account data store 335. In various embodiments, controlled communication server 100 may additionally include various components of the example machine of FIG. 2. It is noted that the modules comprise instructions, e.g., instructions 224 executable by the processor 202, to perform the functionality further described herein.

When using controlled electronic communication, to facilitate various functions, a user can create an account. The account information can be maintained in account data store 335, which is one means of performing this function. Account data store 335 can store profile information for registered users. Each user is associated with a unique user identifier, such as a userID, a user name, or a user number. A user's user identifier is assigned by account module 330. Available user identifiers are stored in account data store 335. Alternatively, account module 330 may generate new user identifiers based on previously assigned user identifiers.

In one embodiment, account data store 335 includes account management information, such as account type, e.g., free or paid; usage information for each user, e.g., security settings; personal configuration settings; etc. Account module 330 can be configured to update and/or obtain user account details in account data store 335. An account can be associated with multiple clients 130. Account module 330 can be configured to interact with any number of other modules in controlled communication server 100. Account data store may include characteristics of clients 130. Characteristics include hardware model information, network capabilities, operating system information, messaging and notification capabilities, and the like.

In some embodiments, a user can access controlled electronic communication via a web interface generated by user interface module 340. For example, the user can navigate in a web browser to a web address provided by controlled communication server 100.

In various embodiments, client information module 300 receives, handles, and sends client information. An example of client information is an initiation request. For example, an initiation request is sent by a client 130A if a user of client 130A requests to initiate communication with a user of another client 130B. In one embodiment, client information module 300 stores a record of each initiation request in request data store 305.

Another example of client information is an availability status of a user of a client 130. An availability status indicates whether a user is available to initiate voice communication. In one embodiment, client information module 300 stores a record of each availability status in status data store 315 for later retrieval by status module 310. A client 130 may send an availability status to client information module 300 as part of an initiation request. Additionally, a client 130 may send an availability status in response to an availability request sent by client information module 300. For example, client 130A includes an availability status of ‘available’ as part of an initiation request to initiate communication with client 130B. The availability status of the user of client 130A is updated in status data store 315. In response to client information module 300 receiving the initiation request from client 130A, an availability request is sent to client 130B. In response, client 130B sends an availability status of ‘available’ to client information module 300. The availability status of the user of client 130B is updated in status data store 315. Status module 310 detects that the availability status of both clients is ‘available,’ and thus sends a notification to client 130A, which includes instructions to initiate communication.

### Example Client

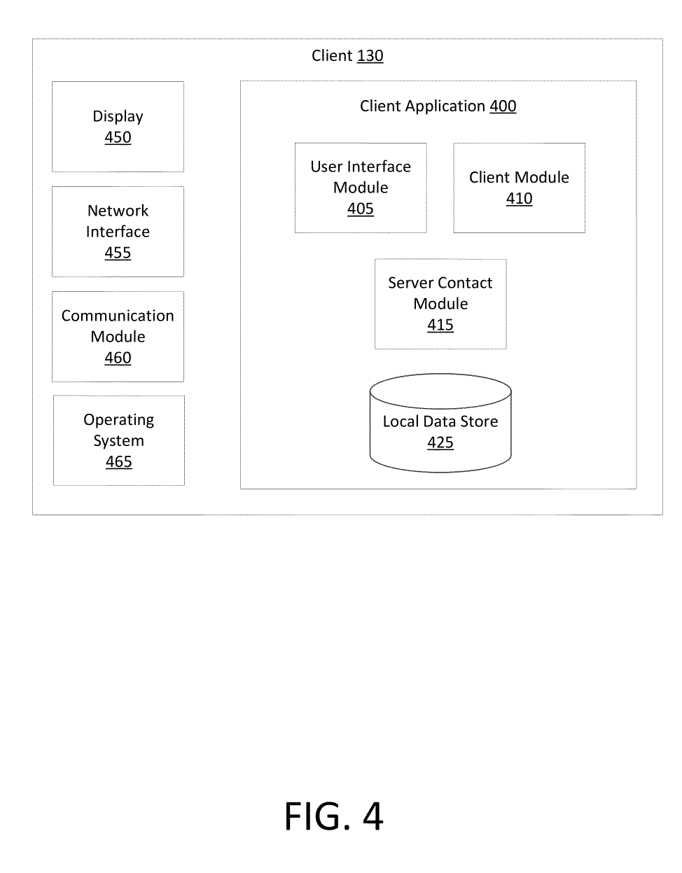

FIG. 4 is a block diagram illustrating the components of an example client 130 according to one embodiment. In this example, client 130 includes client application 400, display 450, network interface 455, communication module 460, and operating system 465. Display 450 provides information to a user, and in certain clients 130 includes a touchscreen. Network interface 455 allows the app client 130 to communicate with controlled communication server 100 as well as with other clients 130 via network 110. In various embodiments, network interface 355 is capable of communication via data networks and/or telecommunications networks (including mobile communication networks). Operating system 465 executes various software modules such as client application 400, an SMS application, and native notification applications. Operating system 465 also displays information from applications executing on client 130 to a user via display 450. In various embodiments, server contact module 415 communicates with various modules of controlled communication server 100 to facilitate controlled electronic communication.

Client application 400 includes user interface module 405, client module 410, status module 415, request module 420, and local data store 425. In one embodiment, user interface module 405 generates an interface through which information is entered and displayed. The generated interface is provided to the user by display 450. Client application 400 stores content accessed from a data store at controlled communication server 100 in local data store 425. Communication module 460 is configured for electronic communication via network 110. In some embodiments, communication module 460 allows inter-device audio and/or video communication over a mobile communication network. In other embodiments, communication module 460 uses the Internet for inter-device audio and/or video communication. In various embodiments, client module 410 communicates with various components of client 130, including network interface 455, communication module 460, and operating system 465. In one embodiment, client module 410 is configured to communicate with communication module 460 to place an audio and/or video call to another device. For example, responsive to server contact module 415 receiving a notification from controlled communication server 100 that includes instructions to initiate communication, client module 410 instructs communication module 460 to initiate communication.

In various embodiments, requests and notifications are sent by controlled communication server 100 and client 130 using messaging services or other communication services (e.g., SMS messages, native device messages, internal messages, etc.). Examples of native device messaging systems include iOS Notifications by APPLE INC., Cupertino, Calif. and Android Notifications by GOOGLE INC., Mountain View, Calif. Internal messages are sent when the client application 400 of a client has an active message-data connection with controlled communication server 100. An active message-data connection typically exists if the client application of the system is open and displayed on the client.

### Example Process for Facilitating Controlled Communication

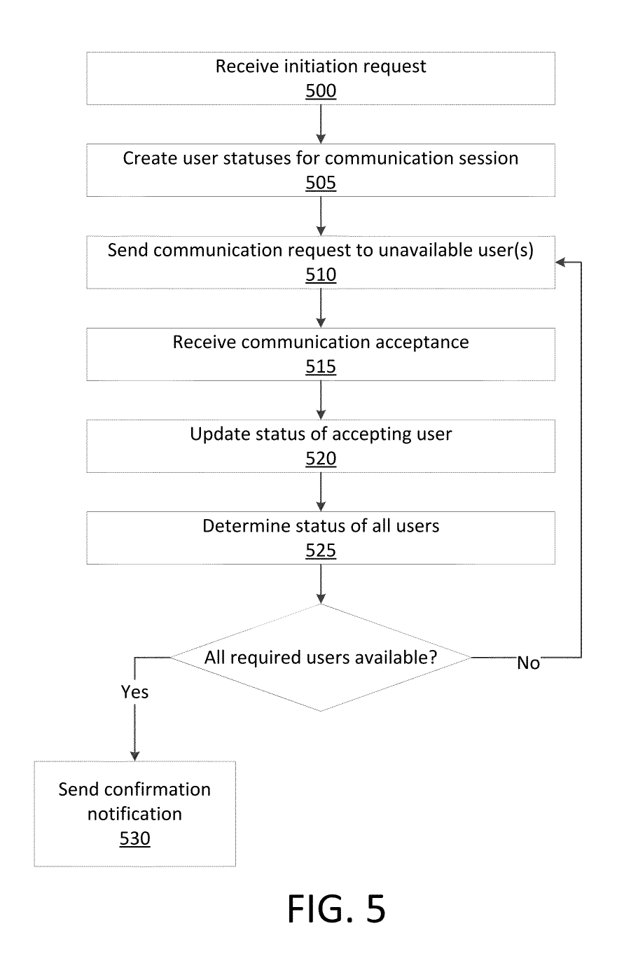

FIG. 5 illustrates an example process for facilitating controlled electronic communication. In this example, client information module 300 receives 500 an initiation request from server contact module 415 of a client 130, which has an associated initiating user. In one embodiment, the initiation request indicates an availability of the initiating user to begin a communication session with a secondary user using communication modules 460 of clients 130. In another embodiment, the initiation request indicates an availability of the initiating user to begin a communication session with a plurality of secondary users. In one embodiment, one or more of the plurality of secondary users are required users and one or more of the plurality may be optional users. The initiating user may choose which of the users are required users and which of the users are optional users via a user interface of client application 400. All of the required users must participate in the communication session and thus must have an availability status of ‘available’ before a communication session may begin. The participation of optional users is optional, so optional users are included in the communication session only if they have an availability status of ‘available’ before the beginning of the communication session. If, for example, all of the required users have availability statuses of ‘available’, but one optional user has an availability status of ‘unavailable’, the communication session will begin without the participation of the unavailable optional user. In one embodiment, the unavailable user is permitted to participate in the communication session if that user's availability status becomes ‘available’.

In various embodiments, the initiation request indicates an availability time range during which the initiating user will be available to begin the communication session. In one embodiment, the availability time range may be specified by the user via a user interface provided by client application 400. Client information module 300 stores a request record in request data store 305. The request record includes the user identifiers of the initiating user and any secondary users, as well as whether each user is a required user or an optional user.

Status module 310 creates 505 availability status entries for the initiating user and the secondary user(s) for the communication session in status data store 315. In one embodiment, the availability status of the initiating user is set to ‘available’ in status data store 315. In one embodiment, the availability status of the secondary user(s) is set by default to ‘unavailable’. The availability status entries are unique to the particular communication session, and accordingly, each user may have multiple availability status entries, each corresponding to one of several communication sessions.

The availability status entry for the initiating user may have an associated entry corresponding to the initiating user's availability within an availability time range. In one embodiment, status module 310 changes the availability status of the initiating user to ‘unavailable’ if the current time is not within the availability time range. The availability time range may be pre-set by the initiating user in the client application 400.

Client information module 300 sends 510 a communication request to a client 130 of each user in the request record that has an availability status of ‘unavailable’ in status data store 315. In another embodiment, client information module 300 sends 510 a communication request to all users in the request record. In one embodiment, the communication request is displayed to the recipient by a user interface of client application 400. In various embodiments, the communication request displays other users associated with the communication request, including the initiating user, and allows the recipient to accept or reject the communication request. Accepting the communication request indicates that the recipient is available to begin a communication session with the other participants. In one embodiment, if a required user rejects the communication request (e.g. by not accepting the request, by explicitly denying the request, etc.), the request is terminated and the communication session will not begin. If an optional user rejects the communication request, the availability status of the optional user stays at ‘unavailable’ and the request and session may proceed normally but without the optional user's participation. In another embodiment, if a required user rejects the communication request, other users are prompted to continue with the request and communication session without the participation of the required user. In one embodiment, the recipient is also able to set an availability time range via a user interface of client application 400. In various embodiments, communication request data is stored in request data store 305, local data store 425, or both, and availability status data is stored in status data store 315, local data store 425, or both.

Client information module 300 receives 515 a communication acceptance from a recipient of the communication request. In step 520, status module 310 updates 520 the status of the accepting user in status data store 315. In some embodiments, status module 310 also stores an availability time range of the accepting user in status data store 315. In one embodiment, status module 310 changes the availability status of the accepting user to ‘unavailable’ if the current time is not within the availability time range.

Status module 310 determines 525 the availability status of all users associated with the communication session from status data store 315. If all required users have an availability status of ‘available’, client information module 300 sends 530 a confirmation notification to the accepting user. The confirmation notification includes instructions to begin the communication session with the available users. Available users may include both required users and optional users with an availability status of ‘available’. In one embodiment, the instructions are received by client module 410, which communicates the instructions to communication module 460 to begin the communication session. If not all required users have an availability status of ‘available’, the process returns to step 510. In another embodiment, if two or more users have an availability status of ‘available’, the available users are given an option to begin the communication session without the unavailable users. Client information module 300 sends a communication request to each unavailable user unless the user has not yet responded to a prior communication request or the user is an optional user and has rejected a prior communication request. The process continues until it reaches step 530 or until all users besides the initiating user have rejected the communication request.

### Example User Interfaces

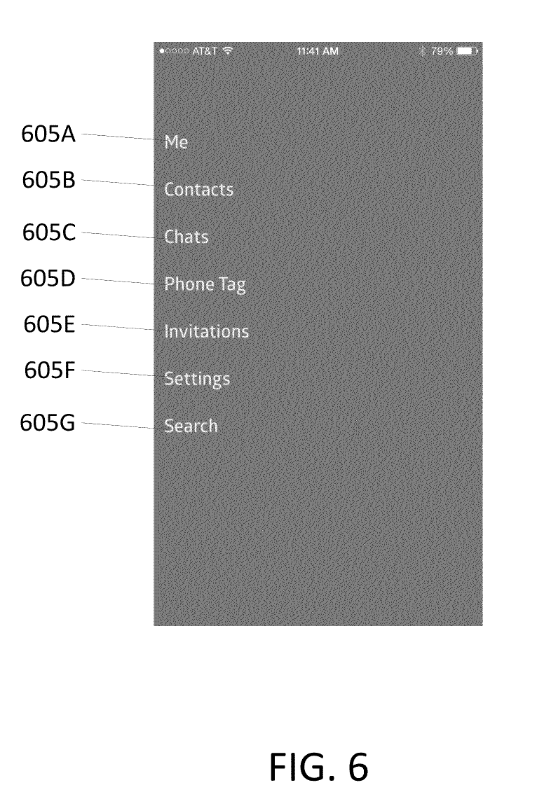

FIG. 6 shows an example user interface for facilitating controlled electronic communication according to one embodiment. In various embodiments, user interface module 340, user interface module 405 or both, provide user interfaces through which information is entered and/or displayed. By using control elements 605A-605G (generally 605), a user can access various parts of the user interface that correspond to controlled electronic communication. In the present embodiment, selecting control element 605A allows a user to access and manage the user's account information including the user's contact information. Selecting control element 605B, allows a user to access a list of contacts and their corresponding contact information. The contact information may be stored in local data store 425 or on controlled communication server 100. Selecting control element 605C allows a user to access a chat interface for exchanging messages with other users. Selecting control element 605D allows a user to access information relating to controlled electronic communication, such as communication requests. Selecting control element 605E allows a user to access and manage invitations for using controlled electronic communication. By selecting control element 605F, a user may adjust various settings related to the user interface and the controlled electronic communication. Selecting control element 605G allows a user to search within client application 400.

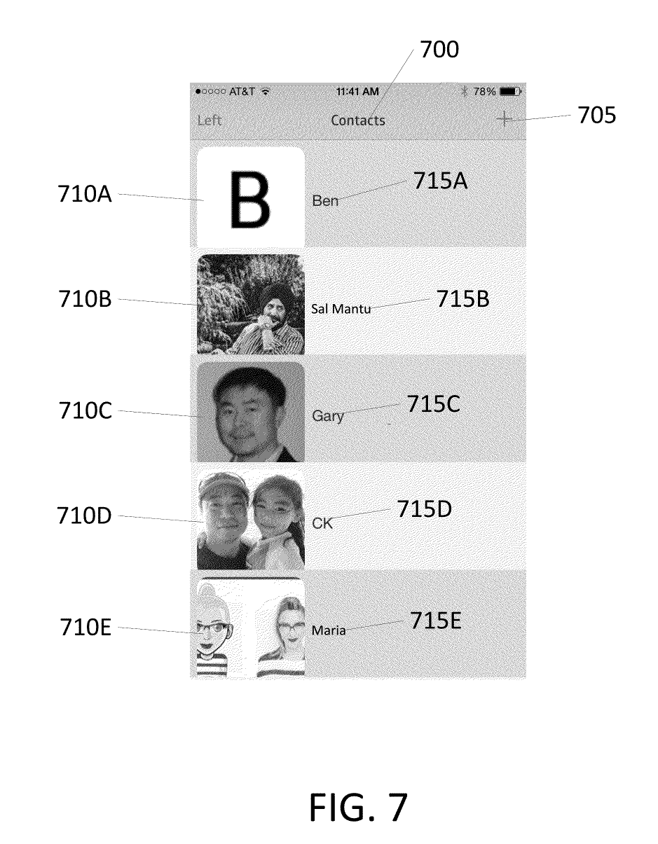

FIG. 7 shows an example user interface for viewing and managing contacts according to one embodiment. The user interface of FIG. 7 may be displayed, for example, when a user selects control element 605B, ‘Contacts’. In this example, user interface element 700 indicates that the user is viewing a list of contacts. User interface element 705, ‘+’, allows the user to add a new contact, along with that person's contact information. User interface elements 710A-710E (generally, 710) are thumbnail pictures associated with each contact. User elements 715A-715E (generally, 715) display contact names. The user may access a user interface for initiating controlled electronic communication by selecting user interface element 710 or 715, as well as by selecting the area surrounding the elements as indicated in FIG. 7 by alternating areas of shading.

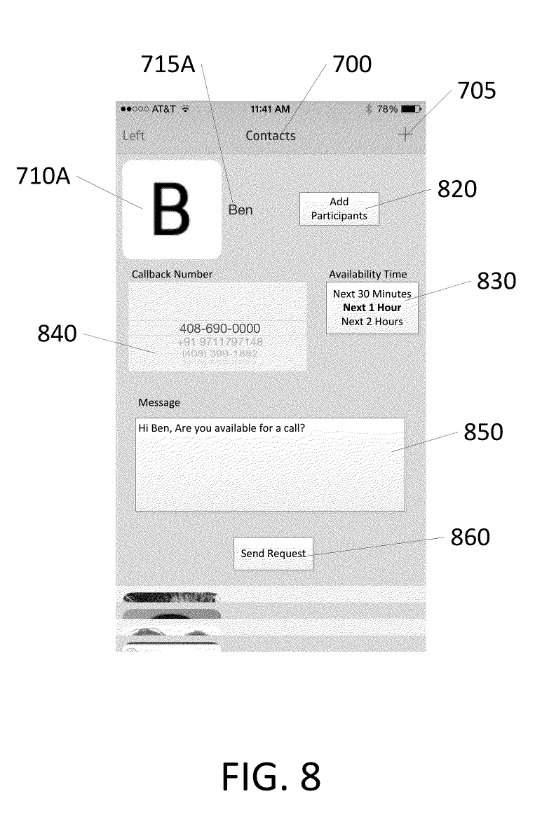

FIG. 8 shows an example user interface for initiating controlled electronic communication according to one embodiment. User interface elements 710A and 715A in FIG. 7 indicate which user has been selected for controlled electronic communication. An initiating user may add more participants to the controlled electronic communication session by selecting user interface element 820. The initiating user chooses an availability time range using user interface element 830. In one embodiment, the time is entered by a user interaction with the user interface (e.g., a keyboard, touchscreen, mouse, etc.). In another embodiment, the time is selected from a predefined set of intervals (e.g. 15 minutes or 30 minutes). In still another embodiment, selection occurs through an automated process (i.e. time is determined from a calendar of scheduled appointments, etc.). The initiating user chooses which phone number or other communication identifier the initiating user would like to use for the communication session using user interface element 840. A user may include a message to the other participant(s) using user interface element 850. The user sends the request by selecting user interface element 860.

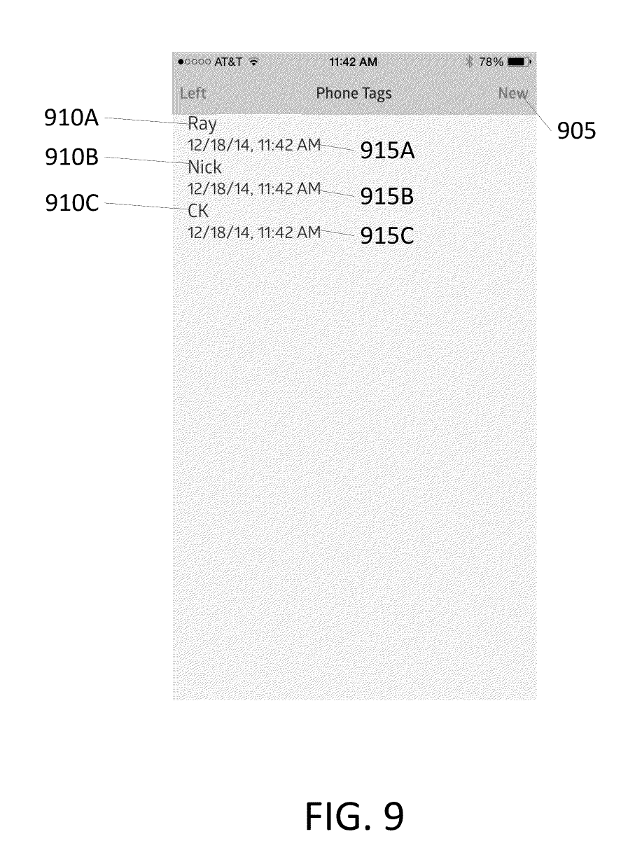

FIG. 9 shows an example user interface for viewing and managing requests for controlled electronic communication according to one embodiment. User interface element 905 allows a user to initiate a new communication session. User interface elements 910A-910C (generally, 910) show the user a list of names corresponding to previous communication requests. User interface elements 915A-915C (generally, 915) show the time and date of each communication request. A user may select user interface elements 910 or 915 to access a user interface for viewing and responding to a communication request.

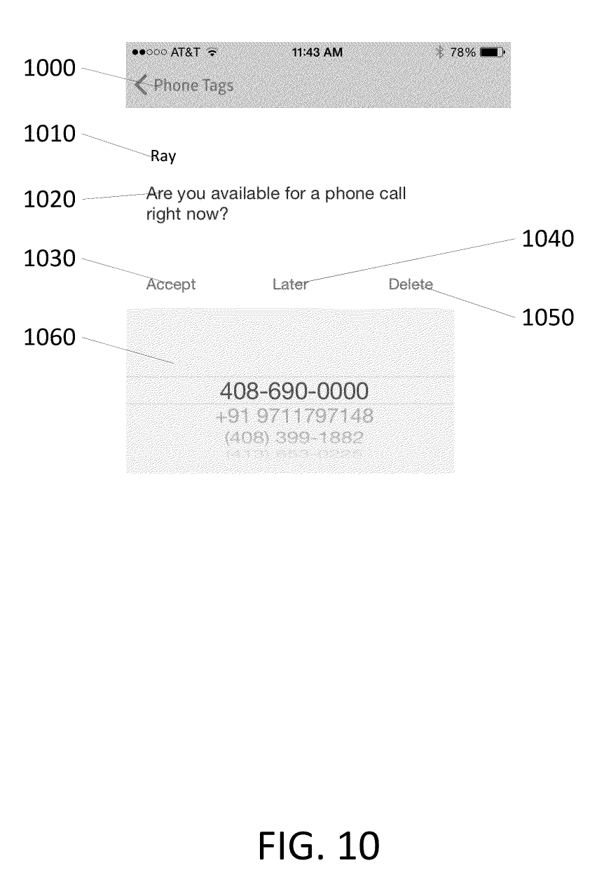

FIG. 10 shows an example user interface for viewing and responding to a communication request according to one embodiment. User interface element 1000 allows the user to return to the user interface of FIG. 9. User interface element 1010 indicates the sender of the communication request. User interface element 1020 displays the message included with the communication request. User interface elements 1030, 1040, 1050 allow a user to respond to the communication request. A user may select user interface element 1030 to accept the request and indicate that the user is available to begin the communication session. The user may alternatively select user interface element 1040 to specify an availability time range in the future by being presented a user interface such as that shown and described with FIG. 8. The user may also select user interface element 1050 to reject and delete the request. User interface element 1060 allows the user to select which phone number or other communication identifier the initiating user would like to use for the communication session.

### Additional Considerations

The controlled electronic communication as disclosed provides benefits and advantages that include reducing time and effort expended toward initiating voice communication between two or more parties. For example, the disclosed configuration allows a second party that is unable to take a call or message from a first party to set up a particular time and communication identifier for the first party to retry. Moreover, if the first party is not available at that requested time, the first party can communicate, through a user interface as disclosed, the first party's particular time and communication identifier.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1-4. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 202, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine but possibly deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other but still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “the,” “a,” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for facilitating controlled electronic communication through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for facilitating controlled electronic communication, the method comprising:
receiving an initiation request from a client of a primary user to begin a communication session, the initiation request indicating a secondary user to be included in the communication session;
responsive to receiving the initiation request, creating an availability status of the primary user corresponding to an availability of the primary user to initiate the communication session;
transmitting a communication request to a client of the secondary user to begin the communication session;
receiving an availability notification from the client of the secondary user, the availability notification indicating an availability of the secondary user to initiate the communication session;
determining, in response to receiving the availability notification, the availability status of the primary user; and
sending, in response to determining that the primary user is available to initiate the communication session, a confirmation notification to the client of the secondary user, the confirmation notification comprising instructions to commence the communication session.

2. The method of claim 1, wherein the initiation request further comprises an availability time range of the primary user.

3. The method of claim 2, further comprising:
determining whether a current time is within the availability time range of the primary user; and
responsive to determining that the current time is not within the availability time range of the primary user, changing the availability status of the primary to user to reflect an unavailability to initiate the communication session.

4. The method of claim 1, wherein the availability notification further comprises an availability time range of the secondary user.

5. The method of claim 4, wherein the determining and sending do not occur if a current time is not within the availability time range of the secondary user.

6. The method of claim 1, wherein the communication session is a voice call on an electronic device.

7. The method of claim 1, wherein the instructions to commence the communication system cause the communication session to begin without a user input by the secondary user.

8. A system for facilitating controlled electronic communication, the system comprising:
a processor configured to execute instructions;
a non-transitory, non-volatile storage medium containing instructions that when executed by the processor causes the processor to:
receive an initiation request from a client of a primary user to begin a communication session, the initiation request indicating a secondary user to be included in the communication session;
responsive to receipt the initiation request, create an availability status of the primary user corresponding to an availability of the primary user to initiate the communication session;
transmit a communication request to a client of the secondary user to begin the communication session;
receive an availability notification from the client of the secondary user, the availability notification indicating an availability of the secondary user to initiate the communication session;
determine, in response to receiving the availability notification, the availability status of the primary user; and
send, in response to determining that the primary user is available to initiate the communication session, a confirmation notification to the client of the secondary user, the confirmation notification comprising instructions to commence the communication session.

9. The system of claim 8, wherein the initiation request further comprises an availability time range of the primary user.

10. The system of claim 9, further comprising instructions that when executed causes the processor to:
determine whether a current time is within the availability time range of the primary user; and
responsive to the determination that the current time is not within the availability time range of the primary user, change the availability status of the primary to user to reflect an unavailability to initiate the communication session.

11. The system of claim 8, wherein the availability notification further comprises an availability time range of the secondary user.

12. The system of claim 11, wherein execution of the instructions to determine and send does not occur if a current time is not within the availability time range of the secondary user.

13. The system of claim 8, wherein the communication session is a voice call on an electronic device.

14. The method of claim 8, wherein the instructions to commence the communication system cause the communication session to begin without a user input by the secondary user.

15. A computer readable medium configured to store instructions, the instructions when executed by a processor cause the processor to:
receive an initiation request from a client of a primary user to begin a communication session, the initiation request indicating a secondary user to be included in the communication session;
responsive to receiving the initiation request, create an availability status of the primary user to reflect an availability of the primary user to initiate the communication session;
transmit a communication request to a client of the secondary user to begin the communication session;
receive an availability notification from the client of the secondary user, the availability notification indicating an availability of the secondary user to initiate the communication session;
determine, in response to receiving the availability notification, the availability status of the primary user; and
send, in response to determining that the primary user is available to initiate the communication session, a confirmation notification to the client of the secondary user, the confirmation notification comprising instructions to commence the communication session.

16. The computer readable medium of claim 15, wherein the initiation request further comprises an availability time range of the primary user.

17. The computer readable medium of claim 15, further comprising instructions that cause the processor to:
determine whether a current time is within the availability time range of the primary user; and
responsive to determining that the current time is not within the availability time range of the primary user, change the availability status of the primary to user to reflect an unavailability to initiate the communication session.

18. The computer readable medium of claim 15, wherein the availability notification further comprises an availability time range of the secondary user.

19. The computer readable medium of claim 18, wherein the determining and sending do not occur if a current time is not within the availability time range of the secondary user.

20. The computer readable medium of claim 15, wherein the communication session is a voice call on an electronic device.

21. The computer readable medium of claim 15, wherein the instructions to commence the communication system cause the communication session to begin without a user input by the secondary user.
